(19) United States
(12) Patent Application Publication
(10) Pub. No.: US 2014/0013082 A1
(43) Pub. Date: Jan. 9, 2014

(54) RECONFIGURABLE DEVICE FOR REPOSITIONING DATA WITHIN A DATA WORD

(71) Applicants: Amit Agarwal, Hillsboro, OR (US); Steven Hsu, Lake Oswego, OR (US); Ram Krishnamurthy, Portland, OR (US)

(72) Inventors: Amit Agarwal, Hillsboro, OR (US); Steven Hsu, Lake Oswego, OR (US); Ram Krishnamurthy, Portland, OR (US)

(73) Assignee: Intel Corporation, Santa Clara, CA (US)

(21) Appl. No.: 13/976,923

(22) PCT Filed: Dec. 30, 2011
(86) PCT No.: PCT/US11/68224

§ 371 Date: Jun. 27, 2013

(51) Int. Cl. G06F 9/30

(52) U.S. Cl. CPC G06F 9/30032
USPC 712/204

(57) ABSTRACT

Disclosed is a system and device and related methods for data manipulation, especially for SIMD operations such as permute, shift, and rotate. An apparatus includes a permute section that repositions data on sub-word boundaries and a shift section that repositions the data distances smaller than the sub-word width. The sub-word width is configurable and selectable, and the permute section and shift section may operate on different boundary widths. In a first stage, the permute section repositions the data at the nearest sub-word boundary and, in a second stage, the shift section repositions the data to its final desired position. The shift section includes multi-stages set in a logarithmic cascade relationship. Additionally, each shifter within each of the multi-stages is highly connected, allowing fast and precise data movements.

### TECHNICAL FIELD

The disclosed technology relates to parallel data repositioning circuits, and, more particularly, to a high-efficiency device that performs permute, shift, and rotate functions on data at selectable sub-word lengths.

### BACKGROUND

To remain popular with customers, microprocessors in mobile and other devices must perform well at a variety of tasks. Some of the most taxing functions for microprocessors include video processing, graphics processing, high quality audio processing, and real-time data processing, all of which are important to customers. These applications all have high data throughput requirements, which translates to high power requirements, while at the same time the platform also requires low power budgets to maximize battery life.

Many microprocessor instruction set architectures include Single Instruction Multiple Data (SIMD) processing instructions, which perform the same instruction, or set of instructions, on multiple pieces of data. Such instructions are much more efficient than requiring each data portion to have its own instruction. Many of these instruction set architectures include sub-word parallel integer/floating point arithmetic vector instructions, such as the AVX and SSE instruction sets. These instruction sets improve performance of such data intensive applications by executing several operations on low-precision data in parallel. SIMD architectures are commonly used for handling the high throughput demands of such instructions. Key data functions in these instruction sets include permute, shift, and rotate, all of which are power and performance critical components of specialized hardware structured to perform SIMD instructions.

Typical shift/rotate units in existing circuits have fixed operand bit-widths and parallelism. However the configuration of bit widths and degree of parallelism have different requirements for different applications. One of the ways to handle the requirements of the various applications is to have a shift/rotate circuit that includes separate shifters for each of the multiple parallel data widths, however this results in considerable area and leakage power overhead.

FIG. 1 is a functional block diagram of a conventionally designed shift/rotate device that includes multiple shifters of varying widths. A shift/rotate system 100 includes a series of four shift/rotate circuits 110, 112, 114, and 116, each of which has a data word width of 64 bits. The 64-bit data word is configurable for sub-word sizes of 3 bits, 16, bits, and 8 bits. Together, the shift/rotate system 100 can manipulate up to 256 bits.

As is seen in FIG. 1, particular shifters are selected within a shift/rotate circuit, based on the width of the selected sub-word. For example, if the sub-word has an 8-bit width, then the eight, 8-bit shifters will be used to perform the selected shift/rotate action. If instead the sub-word has a width of 32 bits, then the two, 32-bit shifters will be used.

For example, with reference to FIG. 2, assume that an operation is to rotate a 32 bit subword in the right direction a distance of 19 bits. Using conventional shift/rotate system, such as the system 100 of FIG. 1, the 32 bit sub-word would first be loaded into one of the 32 bit shifters of the shift/rotate circuit 110 using a de-multiplexor. Then, the rotate command is executed and the 32 bit shifter would rotate the data 19 positions to the right. The rotated data is finally sent to the output using a 4:1 multiplexor. The 8 bit and 16 bit shifters of the shift/rotate circuit 110 are not used in this operation. Thus, the shift/rotate system 100 is not only large, but also includes several components that will seldom be used, resulting in considerable area and leakage power overhead.

Embodiments of the invention address these and other limitations in the prior art.

### BRIEF DESCRIPTION OF THE DRAWINGS

Embodiments of the present invention are illustrated by way of example, and not by way of limitation, in the drawings and in which like reference numerals refer to similar elements.

FIG. 1 is a functional block diagram of a conventionally designed shift/rotate device.

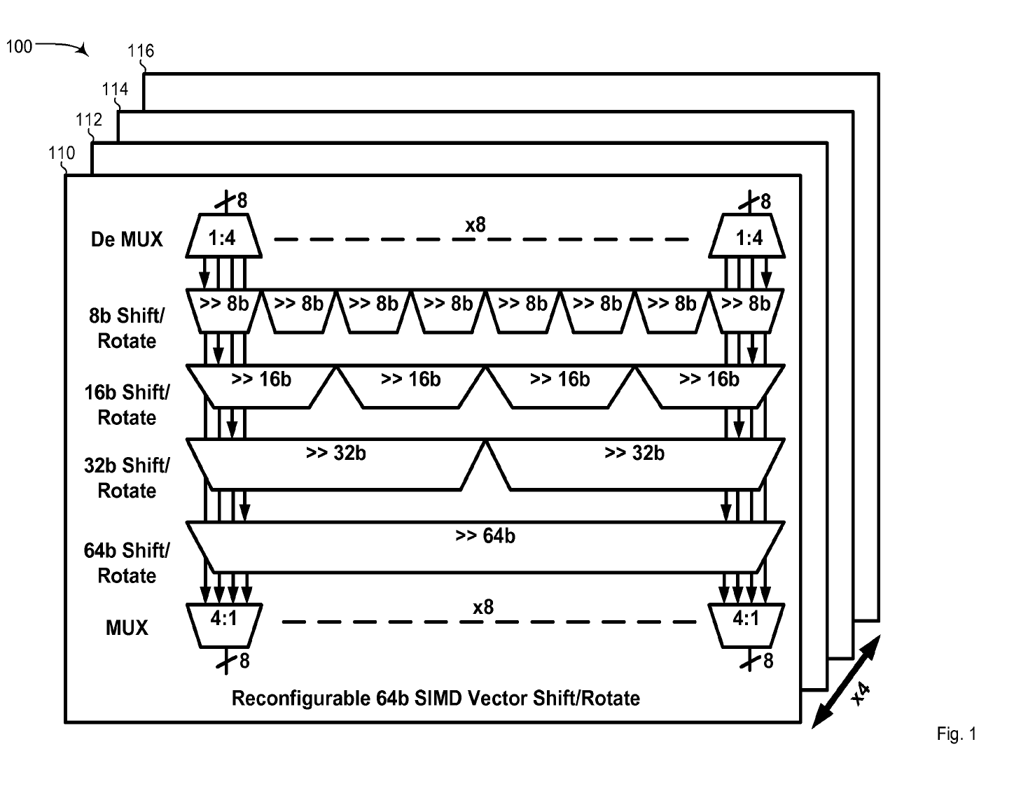

FIG. 2 is a block diagram illustrating shift operation in the shift/rotate device of FIG. 1.

FIG. 3 is a functional block diagram of a permute/shift/rotate device according to embodiments of the invention.

FIG. 4 is a block diagram illustrating a shift operation in the permute/shift/rotate device of FIG. 3

FIG. 5 is a functional block diagram showing additional detail of a permute portion of the permute/shift/rotate device according to embodiments of the invention.

FIG. 6 is a functional block diagram showing additional detail of a shift portion of the permute/shift/rotate device according to embodiments of the invention.

FIG. 7 is a functional block diagram showing further detail of one of the shift portions of the shift device of FIG. 6, according to embodiments of the invention.

FIG. 8 is a schematic diagram illustrating further detail of one stage of one of the shift portions illustrated in FIG. 7, according to embodiments of the invention.

FIG. 9 is a functional block diagram of a computer system in which embodiments of the invention may be implemented.

### DETAILED DESCRIPTION

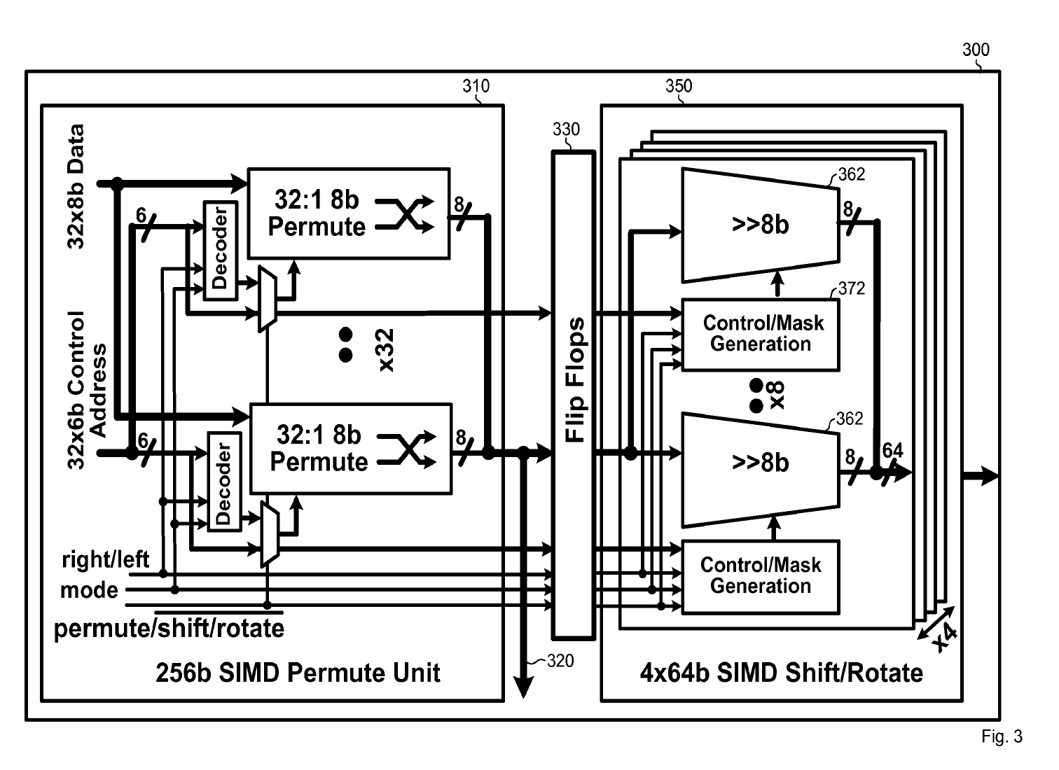

FIG. 3 is a functional block diagram of a permute/shift/rotate device according to embodiments of the invention. A permute/shift/rotate device 300 includes both a permute section 310 and a shift/rotate section 350. For brevity, the permute/shift/rotate device 300 is referred to herein as the data manipulation device 300, the permute section 310 is referred to as the permuter 310, and the shift/rotate section 350 is referred to herein as the shifter 350, regardless of whether the shifter 350 is operating on a shift function or a rotate function, both of which are described in detail below.

The permuter 310 includes 32 separate permute circuits, each of 8-bit granularity. In other words, 8 bits are moved at the same time. In the embodiment illustrated in FIG. 3, the permuter 310 is 256 bits wide, which can execute any permutation across 32 8-bit sub-words,

The shifter 350 includes four separate instances of eight 8-bit shifters 362, as well as control and mask circuitry 372 described below. Each instance of the shifter 350 handles 64 bits in the eight 8-bit shifters, for a total of 256 bits, which matches the data path size of the permuter 310.

In general, in operation, data is rearranged through the data manipulation device 300 in two pipeline stages. In the first pipeline stage, the data is operated on by the permuter 310, and in a second pipeline stage, the data is operated on by the shifter 350. If the desired data manipulation may be performed by the permuter 310 itself, without requiring the shifter 350, then the data manipulation is performed in a single pipeline stage, and is output from the permuter 310 through an output 320. Data manipulations may be performed solely by the permuter 310 if the desired operation occurs on an 8-bit boundary, such as 16-bits, 32-bits, and 64-bit granularity.

For those cases where the data is to be shifted or rotated less than 8 bits, then the permuter 310 need not be used at all, and the shifter 350 solely performs the operation.

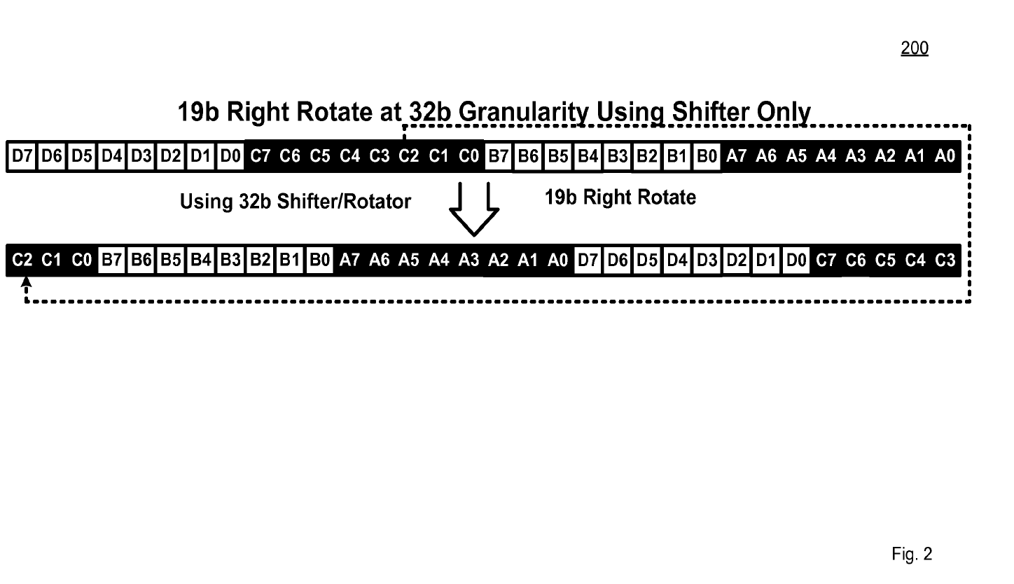

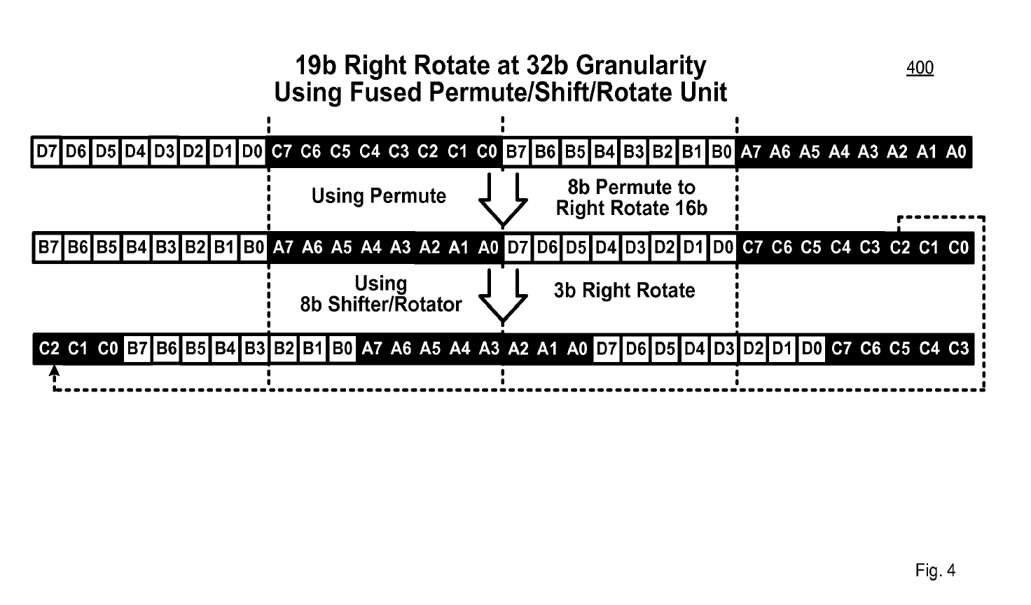

More common, however, is that data manipulations will be larger than 8 bits, will not be performed on 8 bit boundaries, and will instead require 1 bit resolution or granularity. For those cases, the permuter 310 is used to move the data to the closest 8 bit boundary, and then the shifter 350 is used to make the final bit-wise movements. FIG. 4 illustrates an example, using the same example referred to above with reference to FIG. 2. In FIG. 4, a 32-bit data word is desired to be rotated a 19-bit distance to the right. Using embodiments of the invention, this operation is performed in two stages. In a first stage, the 32-bit data word is permuted a 16-bit distance to the right in the first stage using the permuter 310. The 16-bit distance is aligned on the 8-bit boundary, and therefore the permuter 310 is used to perform this first portion of the operation. Next, the shifter 350 is used to rotate the 32-bit data word the remaining 3 bits to the final desired location. A set of registers or flip-flops 330 may be used to store data between the first and second stages.

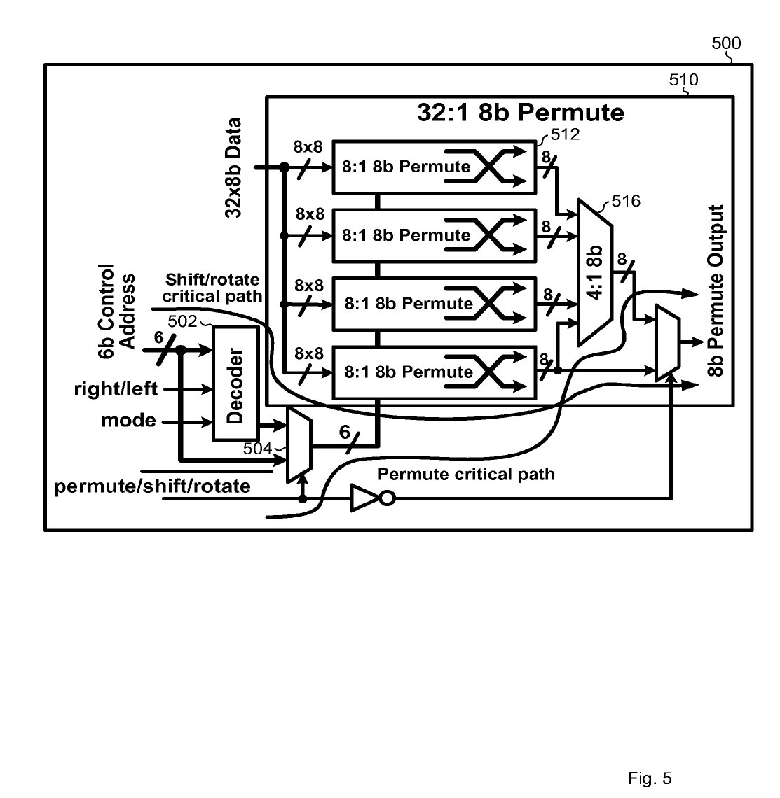

With reference to FIG. 5, which is a functional block diagram showing additional detail of a permute portion of the data manipulation device, when the data manipulation device 500 is in the permute mode, a control address is directly fed to the permuter 510 by way of a selector 504, such as a multiplexor. This results in minimal delay overhead. Instead, when the data manipulation device 500 is in the shift/rotate mode, these address bits are first decoded in a decoder 502. Although the decoding stage takes additional time, in the shift/rotate mode the data is bypassed through the permuter 510 to the final output, and delay gain as a result of bypassing a final 4:1 selector 516 compensates for the added decoder delay during shift/rotate mode.

Decoding the address in the shift mode generates the permute addresses to he operated by the permuter 510 in the first stage, based on the different shift/rotate amounts and operation mode. The operation mode indicates whether data is operating on 8-bit, 16-bit, 32-bit, or 64-bit boundaries. Since the largest granularity shift/rotate operation is 64-bit, only one 8:1 8-bit permute subunit 512 is used to perform a byte wise shuffle during shift/rotate mode. Four permute subunits 512 are illustrated in the manipulation device 500 of FIG. 5 as the maximum data word size for this embodiment is 256 bits.

With reference back to FIG. 3, the data manipulation device 300 includes an input for receiving data in a data word divided into a number of sub-words that have a predetermined width. For instance, a data word may be 64 bits and the sub-words 16 bits each. The data manipulation device also receives a command to reposition the data within the data word. The permuter 310 is structured to reposition the data when the command is to reposition the data a distance of an integer multiple of the predetermined width. The shifter 350 is structured to reposition the data when the command is to reposition the data a distance less than the predetermined width of the sub-word.

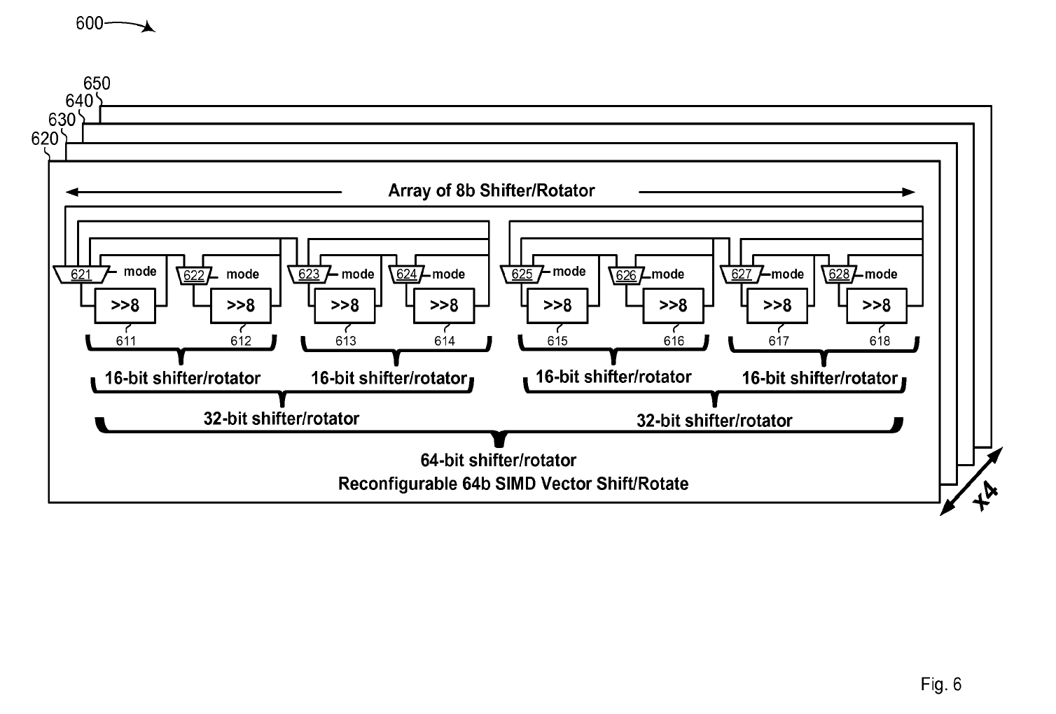

FIG. 6 illustrates further detail of a shifter 600, Which may be an embodiment of the shifter 350 of FIG. 3. The shifter 600 includes four instances of shift units, labeled as 620, 630, 640, and 650, which may be identical. The shift unit 620, for example, includes eight, 8-bit shifters 611-618, as well as eight selectors, such as multiplexors 621-628. To enable multiple granularities, primary inputs and intermediate data loop-back at multiple sub-word (8-bit, 16-bit, 32-bit, 64-bit) boundaries. This adds one of the selectors 621-628 at the boundary of every shift/rotate stage. The selectors may be 4:1, 3:1, or 2:1 depending on its location within the shift unit 620, which selects different loop-back data based on the mode of operation. By coupling the shifters 611-618 to one another in this way, the shifters may operate either individually as 8-bit shifters, or may be grouped to form 16-bit, 32-bit, or 64-bit shifters. For example, in 32-bit mode, four shifters 611-614 operate together as a 32-bit shifter, while the remaining four shifters 615-618 operate as a second 32-bit shifter.

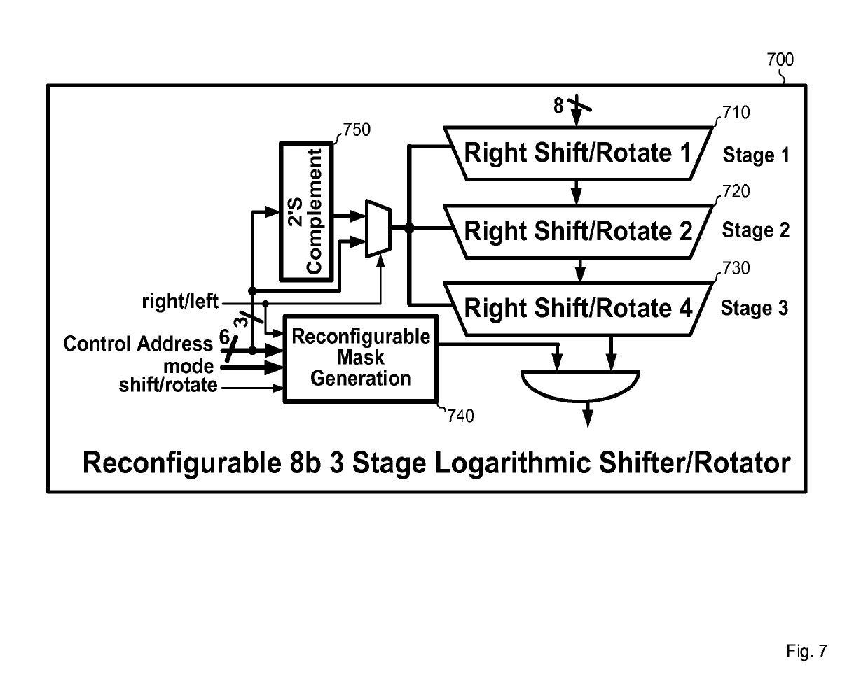

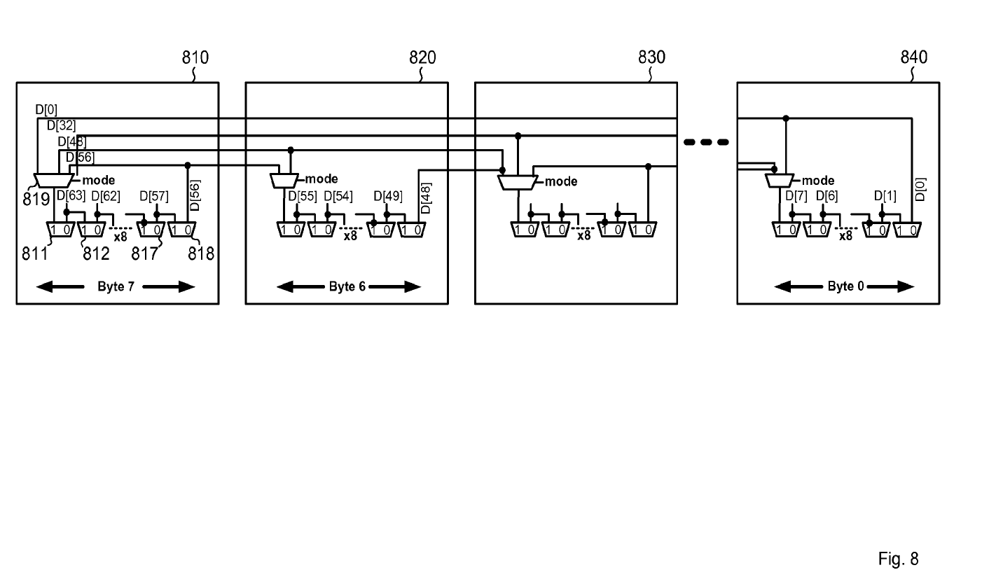

Each of the individual shifters 611-618 include three stages arranged in a logarithmic order, as illustrated in FIG. 7. In FIG. 7 a single shifter 700, which may be an embodiment of one of the shifters 611-618 of FIG. 6, includes a first stage 710, second stage 720, and third stage 730. Each of the stages 710-730 includes a series of selectors OT multiplexers, such as illustrated in FIG. 8. FIG. 8 includes a series of two-bit multiplexors for each byte. For example byte 7 includes eight two-input multiplexors 811-818 (only four of which are illustrated in FIG. 8), and a four-input multiplexor 819. Data lines connect various multiplexors for the different bytes as illustrated. Note that the connections of each of the two-input multiplexors allow the data to be shifted by one bit or not at all, depending on the desired action for that particular stage.

Referring back to FIG. 7, each of the stages 710, 720, and 730 is coupled in series, and each may shift its data a particular distance. For instance, stage one 710, illustrated in FIG. 8, is structured to shift its data by only a single hit distance or not at all. Stage two 720 is structured to shift its data by a two bit distance or not at all. Finally, stage three 730 is structured to shift its data by a four hit distance or not at all. Using the shifters cascade-connected in such a manner, shifting any amount of bit distance is possible. For example, to shift a three-bit distance, the first and second stage 710, 720 would both shift their data, while the third stage would not shift the data passed to it. To shift a four-bit distance, only the third stage 730 would perform its shift operation, and not the first or second stages 710, 720. Using a logarithmic cascade of shifters, data may be moved very efficiently in very few cycles. In other embodiments, the order of the shifters could be reversed, such as the first stage structured to shift a four-bit distance, while the third stage structured to shift only one bit.

Also illustrated in FIG. 7 is a reconfigurable mask generator 740, which operates to generate mask bits used when performing shift functions. Recall from above that the shifter 350 (FIG. 3) may operate to shift or rotate. While shifting, zeros are shifted in from the input side. For example, when an 8-bit subword is shifted. three to the right, three zeros are input to the left. Rotate, on the other hand, wraps the bits being shifted out of one end into the input of the other end. The reconfigurable mask generator allows the output from the third stage 730 of shifters to be nullified, or masked, depending on the desired operation. Also, a twos-complement generator 750 operates to effectively change a right shift to a left shift by twos-complementing the rotate address bits before sending them to a right rotate unit, in a known manner.

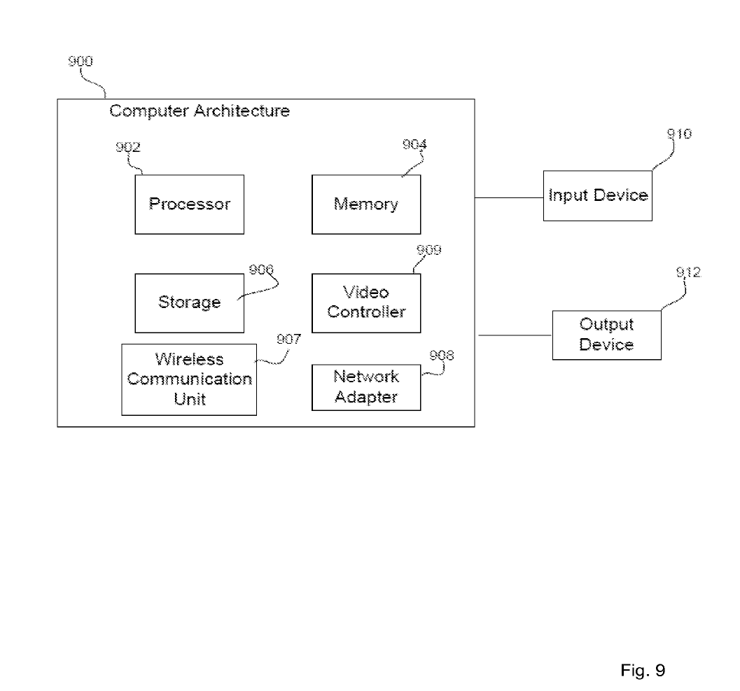

FIG. 9 illustrates an embodiment of a computer architecture 900, which may represent any known computing device, such as a mainframe, server, personal computer, workstation, laptop, handheld computer, telephony device, media player, network appliance, virtualization device, storage controller, etc. The architecture 900 may include a processor 902. (e.g., a microprocessor), a memory 904 (e.g., a volatile memory device), and storage 906 (e.g., a non-volatile storage, such as magnetic disk drives, optical disk drives, a tape drive, etc.). The storage 906 may include an internal storage device or an attached or network accessible storage. Programs in the storage 906 are loaded into the memory 904 and executed by the processor 902 in a known manner, The processor 902 may include SIMD instructions, and the data manipulation device as described herein may be included within the processor 902 for operating on SIMD or other data manipulation instructions.

In some embodiments, a wireless communication unit 907 can communicate with other wireless devices such as cellular phones, wireless voice and data networks, wireless input/output devices, etc. The architecture 900 further includes a network controller or adapter 908 to enable communication with a network, such as an Ethernet, a Fibre Channel Arbitrated Loop, etc. Further, the architecture 900 may, in certain embodiments, include a video controller 909 to render information on a display monitor, where the video controller 909 may be embodied on a video card or integrated on integrated circuit components mounted on a motherboard. In addition or instead of being included on the processor 902, the data manipulation device as described herein may be included within the video controller 909 for operating on SIMD or other data manipulation instructions. An input device 910 is used to provide user input to the processor 902, and may include a keyboard, mouse, pen-stylus, microphone, touch sensitive display screen, or any other activation or input mechanism. An output device 912 is capable of rendering information transmitted from the processor 902, or other component, such as a display monitor, printer, storage, etc.

The network adapter 908 may be embodied. on a network card, such as a Peripheral Component Interconnect (PCI) card, PCI-express, Of some other I/O card, or on integrated circuit components mounted on the motherboard. The storage 906 may be embodied by an internal storage device or an attached or network accessible storage. Programs in the storage 906 are loaded into the memory 904 and executed by the processor 902.

The techniques described herein may be incorporated in various hardware architectures. For example, embodiments of the disclosed technology may be implemented as any of or a combination of the following: one or more microchips or integrated circuits interconnected using a motherboard, a graphics and/or video processor, a multicore processor, hardwired logic, software stored by a memory device and executed by a microprocessor, firmware, an application specific integrated circuit (ASIC), and/or a field programmable gate array (FPGA). The term “logic” as used herein may include, by way of example, software, hardware, or any combination thereof.

Although specific embodiments have been illustrated and described herein, it will be appreciated by those of ordinary skill in the art that a wide variety of alternate and/or equivalent implementations may be substituted for the specific embodiments shown and described without departing from the scope of the embodiments of the disclosed technology. This application is intended to cover any adaptations or variations of the embodiments illustrated and described herein. Therefore, it is manifestly intended that embodiments of the disclosed technology be limited only by the following claims and equivalents thereof.

What is claimed is:

1. An apparatus, comprising:
an input for receiving data in a data word, the data word including a plurality of sub-words having a predetermined width, and for receiving a command to reposition the data within the data word;
a permute section structured to reposition the data when the command is to reposition the data a distance of an integer multiple of the predetermined width; and
a shift section structured to reposition the data when the command is to reposition the data a distance less than the predetermined width of the sub-word.

2. The apparatus of claim 1, in which the predetermined width of the sub-words is configurable.

3. The apparatus of claim 2, in which the input is structured to accept the predetermined width of the sub-words as an operating mode.

4. The apparatus of claim 1, wherein the permute section is additionally structured to reposition the data in a first action when the command is to reposition the data a distance greater than the predetermined width, and in which the shift section is structured to reposition the permuted data in a second action less than the predetermined width.

5. The apparatus of claim 1, further comprising:
a plurality of address decoders in the permute section, each of the plurality of address decoders associated with one of a plurality of permute subsections of the permute section; and, in which each subsection of the plurality of subsections is structured to rearrange data independent of the other subsections.

6. The apparatus of claim 1, further comprising:
a plurality of address decoders in the shift section, each of the plurality of address decoders associated with one of a plurality of shift subsections of the shift section; and, in which each subsection of the plurality of subsections is structured to shift data independent of the other subsections.

7. The apparatus of claim 1, wherein the shift section is also structured to rotate the data.

8. (canceled)

9. (canceled)

10. The apparatus of claim 1, wherein the shift section comprises multiple stages, and in which a first stage comprises:
a series of single-bit shifters; and
a feedback circuit in which outputs from the series of single-bit shifters are fed back as selectable inputs to the series of single-bit shifters.

11. The apparatus of claim 10, wherein the series comprises eight single-bit shifters, and in which the feedback circuit couples an output of a first of the eight single-bit shifters to a second, fourth, and eighth of the eight single-bit shifters in the series of single-bit shifters.

12. The apparatus of claim 11, wherein the output of the first of the eight single-bit shifters is also coupled to its own input.

13. (canceled)

14. A method comprising:
accepting data in a data word, the data word having a plurality of sub-words bounded by a plurality of sub-word boundaries;
accepting a command to rearrange the data within the word;
rearranging the data within the data word using only a permute unit when the command is to rearrange the data to a position aligned with one of the sub-word boundaries; and
rearranging the data with a shift/rotate unit when the command is to rearrange the data less than a smallest of the sub-word boundaries.

15. The method of claim 14, further comprising:
using the permute unit to rearrange the data within the data word to a target sub-word boundary of the plurality of sub-word boundaries that is closest to the final desired position of the data word.

16. The method of claim 14, further comprising:
using the shift/rotate unit to move the data from a position aligned to the target sub-word boundary to the final desired position of the data word.

17. The method of claim 14, in which rearranging the data with a shift/rotate unit comprises:
shifting or rotating the data through a first distance in a first stage;
shifting or rotating the data through a second distance in a second stage; and
shifting or rotating the data through a third distance in a third stage.

18. (canceled)

19. (canceled)

20. The method of claim 14 in which rearranging the data with a shift/rotate unit comprises shifting or rotating the data in either direction.

21. The method of claim 14, further comprising:
storing data before rearranging the data with the shift/rotate unit.

22. The method of claim 14 in which rearranging the data with a shift/rotate unit comprises masking some of the bits during a rotation.

23. A system, comprising:
a processor;
a memory coupled to the processor;
a video controller coupled to the processor and the memory; and
a data manipulation apparatus, including:
an input for receiving data in a data word, the data word including a plurality of sub-words having a predetermined width, and for receiving a command to reposition the data within the data word;
a permute section structured to reposition the data when the command is to reposition the data a distance of an integer multiple of the predetermined width; and
a shift section structured to reposition the data when the command is to reposition the data a distance less than the predetermined width of the sub-word.

24. The system of claim 23, in which the predetermined width of the sub-words is configurable.

25. The system of claim 23, in which the input is structured to accept the predetermined width of the sub-words as an operating mode.

26. The system of claim 23, wherein the permute section is additionally structured to reposition the data in a first action when the command is to reposition the data a distance greater than the predetermined width, and in which the shift section is structured to reposition the permuted data in a second action less than the predetermined width.

27. The system of claim 23, further comprising:
a plurality of address decoders in the permute section, each of the plurality of address decoders associated with one of a plurality of permute subsections of the permute section; and, in which each subsection of the plurality of subsections is structured to rearrange data independent of the other sections.

28. The apparatus of claim 23, further comprising:
a plurality of address decoders in the shift section, each of the plurality of address decoders associated with one of a plurality of shift subsections of the shift section; and, in which each subsection of the plurality of subsections is structured to shift data independent of the other subsections.

29. The system of claim 23, wherein the shift section is also structured to rotate the data.

30. (canceled)

31. (canceled)

32. The system of claim 23, wherein the shift section comprises multiple stages, and in which a first stage comprises:
a series of single-bit shifters; and
a feedback circuit in which outputs from the series of single-bit shifters are fed back as selectable inputs to the series of single-bit shifters.

33. The system of claim 32, wherein the series comprises eight single-bit shifters, and in which the feedback circuit couples an output of a first of the eight single-bit shifters to a second, fourth, and eighth of the eight single-bit shifters in the series of single-bit shifters.

34. The system of claim 33, wherein the output of the first of the eight single-bit shifters is also coupled to its own input.

35. (canceled)
